(19) United States
(12) Patent Application Publication
(10) Pub. No.: US 2024/0197570 A1
(43) Pub. Date: Jun. 20, 2024

(54) MEDICINE DISPENSING APPARATUS

(71) Applicant: TOSHO, INC., Ohta-ku, Tokyo (JP)

(72) Inventors: Yoshihito Omura, Ohta-ku, Tokyo (JP); Syunji Ohgaya, Ohta-ku, Tokyo (JP)

(21) Appl. No.: 18/554,871

(22) PCT Filed: Mar. 31, 2022
(86) PCT No.: PCT/JP2022/016946

§ 371 Date: Oct. 11, 2023

(30) Foreign Application Priority Data
Apr. 15, 2021 (JP) 2021-069338

(51) Int. Cl. A61J 7/00; A61J 1/03

(52) U.S. Cl. CPC A61J 7/0076; A61J 1/03

(57) ABSTRACT

A medicine dispensing apparatus gives a sense of stable operation of discharge of excessive medicines when used with general-purpose medicine feeders. A temporary reserving structure is provided at the lower end portion of a medicine guide structure configured to guide medicines discharged from a general-purpose medicine feeder of a non-cassette, fixed container portion type so as to fall down, the temporary reserving structure being operable to temporarily reserve the medicines and cause the medicines to collectively fall down. When it is detected that an excessive medicine has been discharged from the medicine feeder, packing operation is temporarily stopped and the temporary reserving structure is caused to reserve the medicines, and an operation to draw out medicine feeder mount portions is allowed, and thereafter resumption of the packing operation is allowed when it is detected that the medicine feeder mount portions are drawn out and pushed back.

### TECHNICAL FIELD

The present invention relates to a medicine dispensing apparatus that includes a large number of medicine feeders configured to contain medicines such as tablets, which may be individually discharged and consecutively discharge the medicines, as classified by type, and that automatically discharges and dispenses desired medicines according to a prescription or a medicine dispensation instruction. In particular the present invention relates to a medicine dispensing apparatus including a temporary reserving structure between a medicine guide structure and a medicine collecting structure.

### BACKGROUND ART

There have been put into practical use tablets counting and monitoring apparatuses configured to inspect whether or not an appropriate content is dispensed for each pack after the completion of dispensation by a medicine dispensing apparatus for an elongated package sheet for separately packing medicines such as tablets for each pack. When there is any excess or deficiency of medicines in individual packs, a failure mark etc. is indicated by a marker on the applicable package body (see Patent Document 1, for example).

Some medicine dispensing apparatuses affix a wireless tag to packs immediately after the completion of packing while packing medicines one after another (see Patent Document 2, for example). When the actually input medicines are different from what has been expected, false packing is clarified by writing information reflecting such a difference in a wireless tag and affixing the wireless tag over a printed region of a package band.

Further, many medicine dispensing apparatuses (see Patent Documents 3 and 4, for example) include: a housing; a plurality of medicine feeders configured to contain medicines and consecutively discharge the medicines, and a plurality of medicine feeder storage portions each configured to store the plurality of medicine feeders; a medicine guide structure disposed between a pair of adjacent medicine feeder storage units to guide the medicines discharged from the plurality of medicine feeders included in the pair of medicine feeder storage units to a single outlet port located at a lower part of the medicine guide structure; and a medicine feeder storage portion configured to store the pair of medicine feeder storage units and the medicine guide structure. In the medicine dispensing apparatuses according to the related art, one or more medicines of one or more types are discharged from medicine feeders containing such medicines according to a medicine dispensation instruction, the discharged medicine or medicines are led downward by the medicine guide structure at applicable locations, and thereafter a plurality of medicines having fallen from the medicine guide structure are collected by a medicine collecting structure and put into a packing device located under the medicine collecting structure so that the prescribed medicines are consecutively packed according to the types of medicines.

Medicine dispensing apparatuses including a temporary reserving mechanism between a medicine guide structure and a medicine collecting structure are also practically used (see Patent Documents 3 and 10, for example).

While some temporary reserving mechanisms are of a dependent type that are mounted in a medicine feeder storage portion and are drawable together with medicine feeders and a medicine guide structure (see Patent Document 3, for example), other temporary reserving mechanisms are of an independent type that are mounted under a medicine feeder storage portion and are not necessarily drawn together with medicine feeders and a medicine guide structure.

Irrespective of the medicine type, there are common operation characteristics that tend to cause the packing device to wait for a long time until completion of input of medicines since fluctuations between upper medicine feeders and lower medicine feeders in the length of the medicine fall path from the medicine feeders to the medicine collecting structure and hence the falling time of discharged medicines are increased when the number of rows of the medicine feeders in the medicine feeder storage portion is increased.

The operation characteristics can be addressed by providing the temporary reserving structure, which can isolate the effect of the fluctuations in the falling time of discharged medicines in the medicine guide structure from the medicine collecting structure and hence the packing device located below.

Therefore, in the medicine dispensing apparatus including the temporary reserving structures, the number of rows of the medicine feeders in the medicine feeder storage portion can be increased without adversely affecting the performance of the packing device.

The temporary reserving structure is pre-mounted only in a medicine feeder storage portion in which medicine feeders of a cassette mount-unmount type exclusively for specific tablets, as will be discussed later, are mounted in a large number of rows. The temporary reserving structure is yet to be mounted in a medicine feeder storage portion in which medicine feeder of a non-cassette type adaptable to many types of medicines, also as will be discussed later, are mounted in a small number of rows.

The large number of medicine feeders (tablet feeders) mounted in the medicine dispensing apparatuses each include a container portion configured to contain and hold usually a large number of medicines (tablets) of a single type collectively input and cause the medicines to consecutively fall when driven for discharge, and a base portion (driving portion) configured to support the container portion and drive the container portion for discharge.

Considering much where medicine replenishment is performed is not limited, so-called “medicine feeders exclusively for specific medicines” in which a container portion is a medicine cassette that is removably mountable to a base portion are often used in such medicine feeders (see Patent Document 3, for example).

On the contrary, so-called “medicine feeders adaptable to many types of medicines, i.e. general-purpose medicine feeders”, which place a focus on the wide range of common use for medicines of a variety of shapes and sizes and the ease of adjustment of individual medicines, also have been improved (see Patent Documents 4 and 5, for example) and accordingly have been increasingly used. In the medicine feeders adaptable to many types of medicines, a container portion and a driving portion are integrally fixed.

When medicine feeders adaptable to many types of medicines are to be mounted in a medicine dispensing apparatus in which a large number of medicine feeders are mounted, it is in only a few cases that medicine feeders adaptable to many types of medicines are used for all or most of the medicine feeders. In many cases, however, medicine feeders adaptable to many types of medicines are used for a small number of the medicine feeders, and medicine feeders exclusively for specific medicines are used for most of the medicine feeders.

### RELATED-ART DOCUMENT

### Patent Document

Patent Document 1: Japanese Unexamined Patent Application Publication No. 2006-069618 (JPA 2006-069618)
Patent Document 2: Japanese Unexamined Patent Application Publication No. 2011-120847 (JPA 2011-120847)
Patent Document 3: Japanese Unexamined Patent Application Publication No. 2013-078525 (JPA 2013-078525)
Patent Document 4: Japanese Unexamined Patent Application Publication No. 2021-029378 (JPA 2021-029378)
Patent Document 5: Japanese Patent No. 6736075 (JP 6736075)
Patent Document 6: Japanese Unexamined Patent Application Publication No. 2007-209600 (JPA 2007-209600)
Patent Document 7: Japanese Unexamined Patent Application Publication No. 2017-012696 (JPA 2017-012696)
Patent Document 8: Japanese Unexamined Patent Application Publication No. 2015-012893 (JPA 2015-012893)
Patent Document 9: Japanese Unexamined Patent Application Publication No. 2020-099585 (JPA 2020-099585) Patent Document 10: U.S. Pat. No. 10,052,260 (WO 2013-51313)

### SUMMARY OF INVENTION

### Technical Problem

### [First Technical Issue]

In such a medicine dispensing apparatus in which a large number of medicine feeders exclusively for specific medicines and a small number of medicine feeders adaptable to many types of medicines are mounted, it is possible to preferentially use the medicine feeders of a cassette mount-unmount type exclusively for specific medicines to dispense medicines for which such medicine feeders can be used, and to use the medicine feeders of a non-cassette, fixed container portion type adaptable to many types of medicines in limited situations in which the medicine feeders exclusively for specific medicines cannot be used.

By doing so, it is possible to avoid or reduce the manual medicine dispensing work (see Patent Documents 6 and 7, for example) which is generally troublesome and imposes a mental burden, advantageously reducing the burden and improving the efficiency of medicine dispensation work.

The two types of medicine feeders can be advantageously selectively used as discussed above, since there is a clear difference between the two types.

That is, in the medicine feeders of a cassette mount-unmount type exclusively for specific medicines which have been commonly used in the related art, medicines are clearly separated in the front-rear direction by mechanical means such as a partition member when medicines to be discharged are aligned, and contained in sectioned chambers, one medicine in each chamber (see the device according to Patent Document 8, which is permanently exclusively for specific medicines, and the device according to Patent Document 9, which is exclusively for specific medicines in an assembled state). The medicine feeders exclusively for specific medicines can also be called “medicine feeders of a medicine row front-rear splitting type”.

In the medicine feeders of a non-cassette, fixed container portion type adaptable to many types of medicines which have been put into practical use in recent years (see Patent Document 5, for example), on the contrary, the container portion and the driving portion are integrated as discussed earlier, and solid medicines contained in a random manner are carried from an inclined rotary body on the inner side onto a peripheral edge portion at the upper end of an annular rotary body on the outer side, and aligned in line by a regulating member regulating the lateral width etc. of a medicine transfer path during rotation of the annular rotary body, to be fed into a fall-discharge port. The medicine feeders of a non-cassette, fixed type adaptable to many types of medicines include a member configured to regulate the lateral width of a medicine transfer path, but do not include a member as mechanical means for clearly separating a medicine to be discharged and the following medicine waiting to be discharged, or sectioned chambers. The medicine feeders adaptable to many types of medicines can also be called “medicine feeders of a medicine row front-rear non-splitting type”. As discussed earlier, the medicine feeders of this type are yet to be combined with a temporary reserving structure.

In such medicine feeders adaptable to many types of medicines, in order to prevent discharge of excessive medicines with the medicines continuously rolling even when rotation of the annular rotary body is stopped, measures have been taken to reduce the rotational speed of the annular rotary body when discharge of medicines for a single pack is nearly completed or rotate the annular rotary body in reverse when discharge of medicines for a single pack is completed, and measures have been taken to suppress undesired rolling of medicines by forming grooves etc. extending in the radial direction in the peripheral edge portion at the upper end of the annular rotary body (see Patent Document 5, for example). Therefore, even the medicine feeders of a medicine row front-rear non-splitting type have an excessive discharge prevention function enhanced to a level comparable to that of the medicine feeders of a cassette type.

However, while the clear presence of a partition member for medicine row front-rear splitting between medicines in the aligned state can give an intuitive sense of security to persons who purchase or use the medicine dispensing apparatus, it is difficult to give an intuitive sense of security with the medicine feeders adaptable to many types of medicines not including such a partition member. Moreover, it is difficult to give a sense of security to persons who desire to use the medicine dispensing apparatus etc. with the medicine feeders adaptable to many types of medicines which have been developed later, also from the viewpoint of having been less frequently used and having produced less results than the medicine feeders exclusively for specific medicines which have been developed earlier.

Thus, an object of the present invention is to improve a medicine dispensing apparatus so as to give a sufficient sense of security even if medicine feeders adaptable to many types of medicines are mounted.

### [Second Technical Issue]

In the medicine dispensing apparatuses including the temporary reserving structure interposed between the medicine guide structure and the medicine collecting structure discussed earlier, not only the large number of medicine feeders mounted above, but also the temporary reserving structure located below must be switched between a state of holding medicines and a state of allowing medicines to fall, according to control by a control device. Therefore, in any of the medicine dispensing apparatuses according to the related art, switching is made between a state of holding medicines and a state of allowing medicines to fall by being driven by an electric motor.

Regarding the switching operation, the individual medicine feeders do not operate very frequently, since only medicine feeders containing medicines to be dispensed need to operate while medicine feeders containing medicines other than those to be dispensed do not need to operate. On the contrary, the temporary reserving structure operates frequently, since the temporary reserving structure operates every time packing is performed as with the packing device, irrespective of the types of the medicines. As a result, maintenance such as check and repair of the electric motor also needs to be performed frequently if the electric motor operates frequently.

Thus, a portion of the packing device which includes a plurality of electric motors generally occupies the lower portion of the housing, and is structured to allow the electric motors to be exposed by drawing the device forward out of the housing together with a support substrate.

Therefore, the electric motors of the packing device can be maintained in both the front side and a lateral side and thus with a light work burden.

For the temporary reserving structure integrated between the medicine guide structure and the medicine collecting structure, on the contrary, the drive system of the temporary reserving structure, including a power transmission member and an electric motor, is disposed deep inside the housing, since higher priority is given to cleaning medicine dust etc., which is frequently performed by the user by drawing the medicine guide structure and the medicine collecting structure forward out of the housing. The electric motor and the power transmission member remain deep inside the housing even in medicine dispensing apparatuses in which an open-close member etc. as a main component of the temporary reserving structure can be drawn forward out of the housing (see Patent Document 3, for example). Therefore, maintaining the electric motor of the temporary reserving structure is basically performed in the rear side or a rear lateral side of the housing.

However, large devices such as medicine dispensing apparatuses are often installed side by side along a wall in pharmacies or, even when installed away from a wall, disposed back to back with other devices. Therefore, there are only a few situations in which the electric motor of the temporary reserving structure can be easily maintained from the rear side of the housing and, even when the maintenance is performed in a rear lateral side of the housing, the maintenance is often performed in a narrow space or after temporarily moving a relatively light device etc. disposed nearby, which increases the burden of the maintenance.

Thus, another object of the present invention is to improve a medicine dispensing apparatus such that maintenance for an electric motor of a temporary reserving structure is facilitated.

### Solution to Problem

A medicine dispensing apparatus according to the present invention includes: a housing 10A; a plurality of medicine feeders 13, 86 configured to contain medicines and consecutively discharge the medicines, and a plurality of medicine feeder storage units 131, 132, 133 each configured to store the plurality of medicine feeders 13, 86; a plurality of medicine guide structures 20, 90 provided in correspondence with the medicine feeder storage units 131, 132, 133 to guide the medicines discharged from the plurality of medicine feeders 13, 80 included in the corresponding medicine feeder storage unit 131, 132, 133 to a single outlet port located at a lower part of the corresponding medicine guide structure 20, 90; a plurality of medicine feeder storage portions 12A to 12C each configured to store the corresponding medicine feeder storage unit 131, 132, 133 and the corresponding medicine guide structure 20, 90; a medicine collecting structure 30 disposed in the housing 10A under the plurality of medicine guide structures 20, 90 to collect the medicines having fallen from the plurality of medicine guide structures 20, 90; a packing device 40 provided in the housing under the medicine collecting structure 30 to separately pack the medicines discharged from the medicine collecting structure 30; and a control portion configured to control operation of the plurality of medicine feeders and the packing device. The medicine feeder storage unit 133 included in one 12C of the plurality of medicine feeder storage portions 12A to 12C includes a plurality of medicine feeder mount portions 80 in which a plurality of general-purpose medicine feeders are mounted on a plurality of drawer shelfs 82 provided vertically and configured to be individually drawable, the plurality of general-purpose medicine feeders each including a container portion and a successive discharge mechanism portion that are integrated with each other. One 90 of the plurality of medicine guide structures 20, 90 that is provided in correspondence with the medicine feeder storage unit 133 including the plurality of medicine feeder mount portions 80 is allowed to be drawn out of the housing 10A when all of the plurality of medicine feeder mount portions 80 are drawn out.

In the present invention, in particular, a temporary reserving structure 97 is provided at a lower end portion of the one 90 of the plurality of medicine guide structures 20, 90 that is provided in correspondence with the medicine feeder storage unit 133 including the plurality of medicine feeder mount portions 80, the temporary reserving structure 97 being operable to temporarily reserve the medicines fallen from the medicine guide structure 90 and cause the medicines to collectively fall down into the medicine collecting structure 30. The control portion is configured to also control operation of the temporary reserving structure. When it is detected that an excessive medicine has been discharged from the medicine feeder 86 included in the medicine feeder storage unit 133 including the plurality of medicine feeder mount portions 80 during packing operation, the control portion temporarily stops the packing operation and causes the temporary reserving structure 97 to reserve the medicines. In addition, the control portion allows an operation to draw out the plurality of medicine feeder mount portions 80 included in the applicable medicine feeder storage unit 133, and thereafter allows resuming the packing operation when it is detected that the plurality of medicine feeder mount portions 80 are drawn out of the housing 10A and pushed back.

In the medicine dispensing apparatus according to the present invention, in addition to the medicine feeders 13 such as medicine feeders exclusively for specific medicines that have been developed earlier and have more results of use and have been more familiar to a medicine dispensing person etc., when mounting the general-purpose medicine feeders 86 in the medicine feeder storage portion 12C, whereby the general-purpose medicine feeders 86, that is, medicine feeders adaptable to many types of medicines, which have been developed later and in which not only the driving portion but also the container portion is fixed and no clear partition member is present between front and rear medicines in the aligned state before being consecutively discharged, the medicine feeder storage portion 12C in which the general-purpose medicine feeders 86 are to be mounted is divided into a plurality of medicine feeder mount portions 80 configured to be individually drawable, and the general-purpose medicine feeders 86 are mounted in a distributed manner in the medicine feeder mount portions 80. The temporary reserving structure 97 is provided at the lower end portion of the medicine guide structure 90 shared by the plurality of medicine feeder mount portions 80, and an excessively discharged medicine is reserved in the temporary reserving structure by the control portion not only temporarily stopping the packing operation but also causing the temporary reserving structure 97 to reserve the medicines when discharge of an excessive medicine is detected. The control portion further performs control so as to enable and facilitate the work of manually removing the excessively discharged medicine from the general-purpose medicine feeders.

Specifically, the control portion allows an operation to draw out the medicine feeder mount portions 80 of the applicable medicine feeder storage portion 12C. After that, the applicable medicine feeder mount portions 80 are manually drawn out of the housing to make it possible to draw out the medicine guide structure 90, the medicine guide structure 90 is also manually drawn out of the housing 10A, the excessively discharged medicines are manually selected and taken out of the temporary reserving structure 97 which has been drawn out accordingly, and then the parts which have been drawn out are pushed back into the housing 10A in the reverse order. Then, it is automatically detected that the applicable medicine feeder storage portion 12C is drawn out of the housing and pushed back, which accordingly enables automatic packing operation to be resumed.

In this manner, when an excessive medicine is discharged from the general-purpose medicine feeder 86, a series of control is performed such that the excessively discharged medicine etc. is reserved in the temporary reserving structure 60 and manual work of drawing the temporary reserving structure 97 out of the housing and extracting the excessively discharged medicine is allowed in response to detection of such discharge. Thus, it is possible to avoid undesired packing easily and adequately, even if automatic medicine dispensation is temporarily stopped. Moreover, the excessively discharged medicine that has been extracted can be returned to the source medicine feeder before pushing back the feeder storage portion, and thus is not wasted.

Thus, with the present invention, a user can be given a sufficient sense of security even if the general-purpose medicine feeders 86 of a fixed container portion type which have been developed later are mounted in addition to the medicine feeders 13 of a cassette mount-unmount type which have been developed earlier and have been familiar.

The medicine dispensing apparatus may further include a display member configured to indicate the medicine feeder 86 that has discharged an excessive medicine when such excessive discharge is detected. With such a configuration, the medicine dispensing person etc. can specify the excessively discharged medicine in the temporary reserving structure immediately and easily and return the excessively discharged medicine to an appropriate general-purpose medicine feeder immediately and without being at a loss, by looking at the indication.

Preferably, the control portion CR causes the medicine feeders 86 included in the medicine feeder storage unit 133 including the plurality of medicine feeder mount portions 80 to perform medicine discharge operation and causes the packing device to perform the packing operation without waiting for an instruction for the packing operation when operating power is turned on and during other initial operation. With such a configuration, undesired remaining medicines are automatically discharged and packed and thus can be disposed of reliably and collectively without being overlooked, even if there are remaining medicines that cannot be grasped during initial operation due to past operation, manipulation, etc. that are not automatically detectable.

A plurality of temporary reserving structures 60 each including a reserving portion 65 are also provided under the plurality of medicine feeder storage units 131, 132 included in the plurality of medicine feeder storage portions 12A and 12B other than the one 12C of the plurality of medicine feeder storage portions 12A to 12C. The plurality of temporary reserving structures 60 are each operable to temporarily reserve, in the reserving portions 65, the medicines fallen from a corresponding one of the plurality of medicine guide structures 20 and cause the medicines to collectively fall down into the medicine collecting structure 30. The medicine dispensing apparatus further includes a drive mechanism operable to drive the plurality of temporary reserving structures (60, 97). Preferably, a front-side portion 22 of a lower end portion of an inner wall portion of at least one 20 of the plurality of medicine guide structures 20 is located in rear of a front-side portion 21 of an upper end portion of the inner wall portion of the at least one medicine guide structure 20; a front end of the reserving portion 65 of the temporary reserving structure 60 is located in rear of a front surface of the housing; and an electric motor 51 operable to provide a closing drive force or an opening drive force to the drive mechanism is located in front of the reserving portion 65.

When configured in this manner, some of the medicines discharged from the plurality of medicine feeders are guided along the inner wall portion located on the front side of the medicine guide structure 20 to fall into the reserving portion 65, even when the electric motor 51 is disposed in front of the reserving portion 65 of the temporary reserving structure 60. As a result, the medicines can be reliably introduced from the plurality of medicine feeders into the reserving portion 65, even if the electric motor 51 is disposed in front of the reserving portion 65. In addition, the electric motor 51 can be easily maintained since the electric motor 51 of the drive mechanism is disposed on the front side of the temporary reserving structure 30.

The plurality of medicine feeder storage portions 12A and 12B may be arranged side by side in the housing 10A. A transmission shaft 64a may be provided to extend in a front-rear direction along the reserving portion 65 of the temporary reserving structure 60 provided for the medicine guide structure 20 in any one 12A of the plurality of medicine feeder storage portions 12A and 12B. A transmission mechanism 70 operable to transmit motion of the transmission shaft 64a to a plurality of open-close mechanisms provided for the plurality of medicine feeder storage portions 12A to 12C may be provided in rear of the reserving portion inside the housing 10 The electric motor may drive the transmission shaft. With such a configuration, drive of the electric motor is transmitted rearward via the transmission shaft, even if the installation location of the electric motor is changed from the rear to the front. As a result, the transmission mechanism for allowing the plurality of temporary reserving structures to share the drive of the electric motor is allowed to remain deep inside the housing as in the related art, advantageously reducing the burden of modification such as change in structure or members.

Preferably, the electric motor 51 is located in front of the reserving portion 65 of the temporary reserving structure 60 in one 12A of the plurality of medicine feeder storage portions 12A to 12C that is located closest to a side in the housing. With such a configuration, the electric motor is provided in front of a temporary reserving structure that is located closest to a side when a plurality of temporary reserving structures are provided. Thus, maintenance for the electric motor of the temporary reserving structure can be clearly performed in a front-side lateral location in addition to the front side, further enhancing the degree of freedom in the maintenance.

Preferably, the transmission shaft 64a serves as a support shaft for the open-close mechanism of the temporary reserving structure. When the support shaft for the temporary reserving structure also serves as a transmission shaft, it is not necessary to add a transmission shaft, avoiding an increase in the number of members which tends to incur an increase in the burden of cost and design.

A cam mechanism operable to convert motion for one rotation of an output shaft of the electric motor 51 into reciprocal rotational motion of the transmission shaft 64a may be provided between the electric motor 51 and the transmission shaft 64a, and the transmission mechanism 70 may be composed of a link mechanism. With such a configuration, it is not necessary that the electric motor should be a highly precise one, or that the electric motor should be finely controlled, since a cam mechanism which tends to allow play is used as a transmission portion, even if the transmission mechanism is composed of a link mechanism which tends to involve play. Thus, it is possible to avoid and suppress a cost increase.

Preferably, the link mechanism of the transmission mechanism 70 drives the open-close mechanism of the temporary reserving structure 97 provided at the lower end portion of the medicine guide structure 90 provided in correspondence with the medicine feeder storage unit 133 including the plurality of medicine feeder mount portions 80. With such a configuration, all the temporary reserving structures can be caused to operate in synchronization using a single electric motor. As a result, the number of parts can be reduced.

### BRIEF DESCRIPTION OF DRAWINGS

FIG. 1 illustrates structure of a medicine dispensing apparatus according to a first embodiment of the present invention. FIG. 1A is an exterior perspective view, FIG. 1B is a schematic view illustrating the internal structure, FIG. 1C is an exterior perspective view in which medicine feeder mount portions of a right medicine feeder storage portion have been drawn out, and FIG. 1D is an exterior perspective view of a medicine collecting mechanism.

FIG. 2A is an exterior perspective view in which the leftmost medicine feeder storage portion has been drawn out of the medicine dispensing apparatus, FIG. 2B is a schematic view illustrating the internal structure of a rear-side portion of the leftmost medicine feeder storage portion, FIG. 2C is a schematic view illustrating the internal structure of a front-side portion of the leftmost medicine feeder storage portion, and FIG. 2D is an exterior perspective view in which the leftmost medicine feeder storage portion has been drawn out and a left side plate of a medicine storage has been removed.

FIG. 3 illustrates the structure of a medicine feeder exclusively for specific medicines/FIG. 3A is a side view with a cassette being mounted, FIG. 3B is a partially vertical sectional side view with the cassette being not mounted, FIG. 3C is a horizontal sectional view of the cassette, and FIG. 3D is a partially vertical sectional side view of an essential portion of the cassette.

FIG. 4 illustrates the structure of a general-purpose medicine feeder. FIG. 4A is a plan view of an essential portion and FIG. 4B is a vertical sectional view of the essential portion.

FIGS. 5A to 5D are each a left side view of the medicine dispensing apparatus, and FIG. 5E is a perspective view of a front surface portion of a medicine storage.

FIGS. 6A and 6B are each a left side view of the medicine dispensing apparatus, and FIGS. 6C to 6E are each an exterior perspective view of the medicine collecting mechanism.

FIG. 7A is a left side view of a medicine feeder storage portion and a temporary reserving structure storage portion, and FIG. 7B is a vertical sectional left side view of a medicine guide structure and a temporary reserving structure.

FIGS. 8A to 8C are a plan view, a front view, and a vertical sectional view, respectively, of a single temporary reserving structure and a drive mechanism therefor.

FIGS. 9A to 9C are a plan view, a front view, and a vertical sectional view, respectively, of the single temporary reserving structure and the drive mechanism therefor.

FIGS. 10A to 10C are a plan view, a front view, and a vertical sectional view, respectively, of the single temporary reserving structure and the drive mechanism therefor.

FIG. 11A is a plan view of two temporary reserving structures and a drive mechanism and a power transmission link mechanism therefor, and FIGS. 11B and 11C are each a front view of the link mechanism.

FIG. 12 is a block diagram illustrating the relationship of a control system.

### DESCRIPTION OF EMBODIMENTS

A medicine dispensing apparatus according to an embodiment of the present invention will be described in detail below with reference to the drawings.

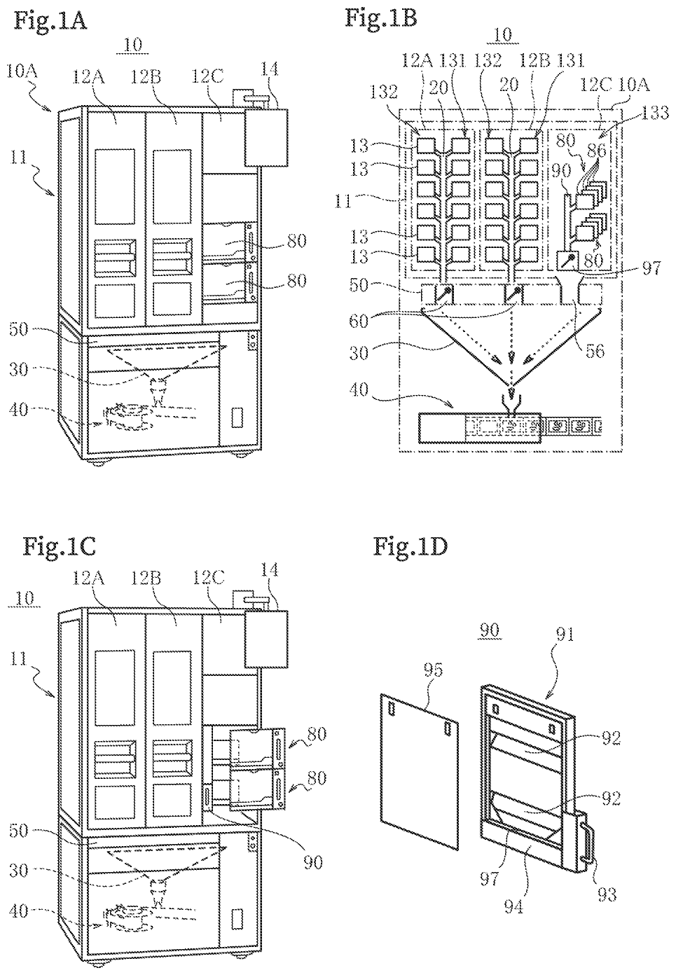

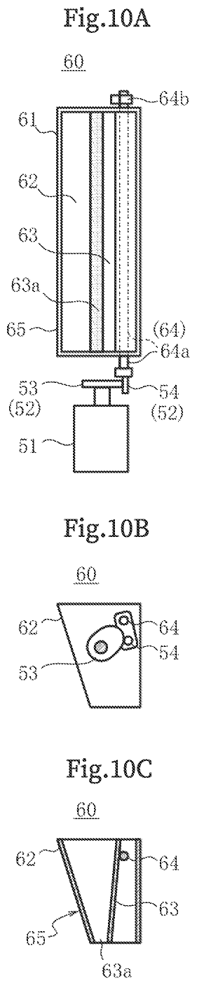

The embodiment illustrated in FIGS. 1 to 12 embodies the present invention. In illustrating the embodiment, fasteners such as bolts, couplers such as hinges, electric circuits such as motor drivers, electronic circuits such as controllers, etc. are not illustrated for simplicity etc., and elements required for or associated with the description of the invention are mainly illustrated.

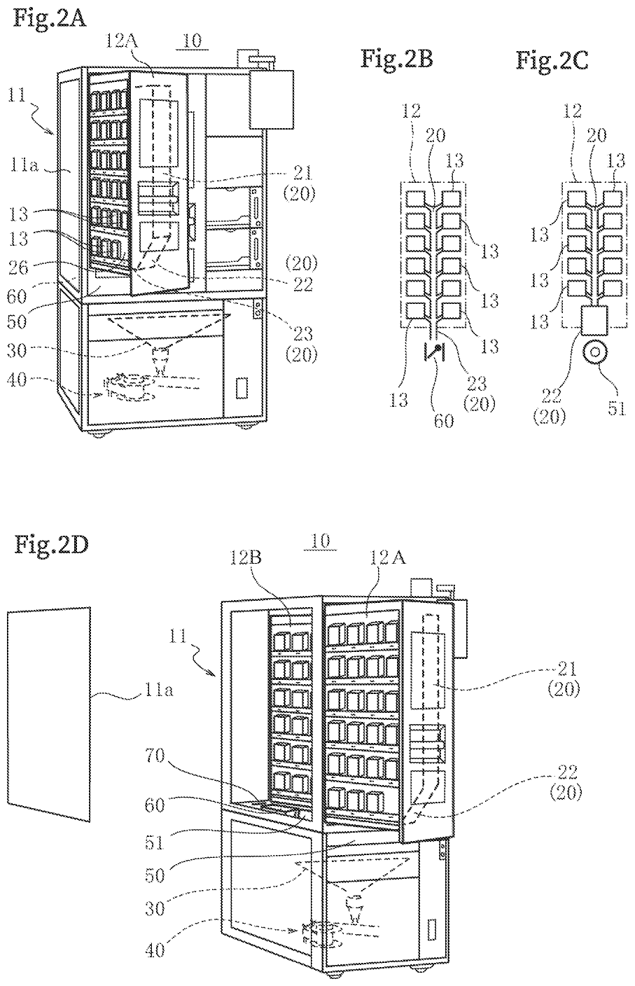

FIGS. 1 and 2 illustrate the overall structure of a medicine dispensing apparatus 10. FIG. 1A is an exterior perspective view of the medicine dispensing apparatus 10 in a normal state such as an automatic packing operation state and a stand-by state. FIG. 1B is a schematic view illustrating the internal structure of the medicine dispensing apparatus 10. FIG. 1C is an exterior perspective view of the medicine dispensing apparatus 10 in which medicine feeder mount portions 80 of a right medicine feeder storage portion 12C have been drawn forward out of a medicine storage 11. FIG. 1D is an exterior perspective view of a medicine guide structure 90 from which a side plate 95 has been removed.

FIG. 2A is an exterior perspective view of the medicine dispensing apparatus 10 in which the leftmost medicine feeder storage portion 12A has been drawn forward out of the medicine storage 11. FIG. 2B is a schematic view illustrating the internal structure of a rear-side portion of the leftmost medicine feeder storage portion 12A. FIG. 2C is a schematic view illustrating the internal structure of a front-side portion of the leftmost medicine feeder storage portion 12A.

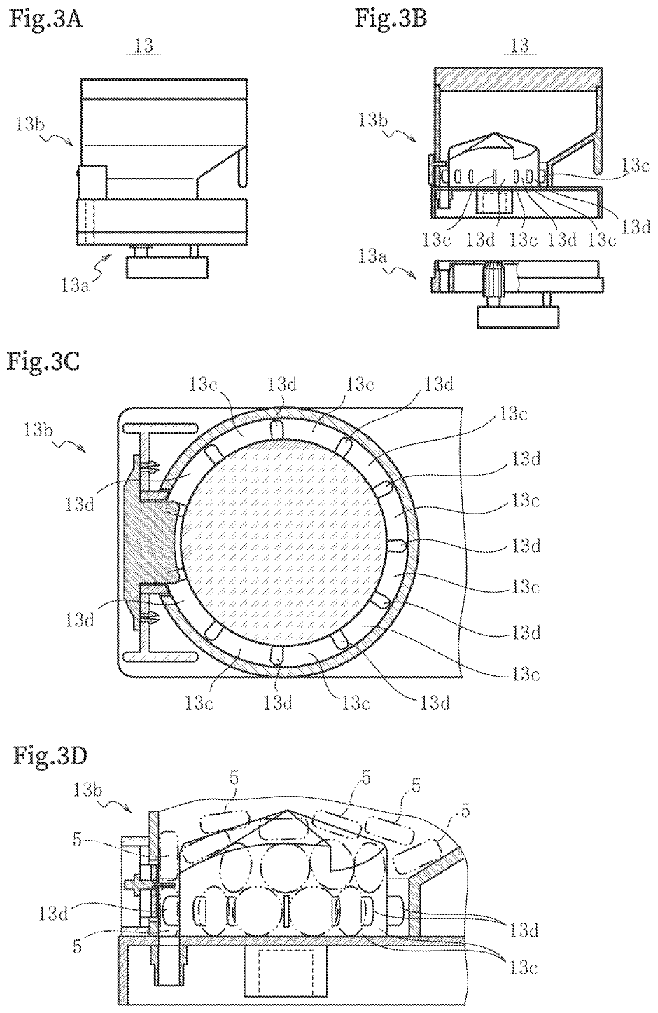

FIG. 3 illustrates the structure of a medicine feeder 13 of a cassette mount-unmount type exclusively for specific medicines. FIG. 3A is a side view of the medicine feeder 13 in a cassette mount state in which a cassette 13b is mounted on a base portion 13a. FIG. 3B is a partially vertical sectional side view of the medicine feeder 13 in a cassette non-mount state in which the cassette 13b has been removed from the base portion 13a. FIG. 3C is a horizontal sectional view of the cassette 13b. FIG. 3D is a partially vertical sectional side view of an essential portion of the cassette 13b.

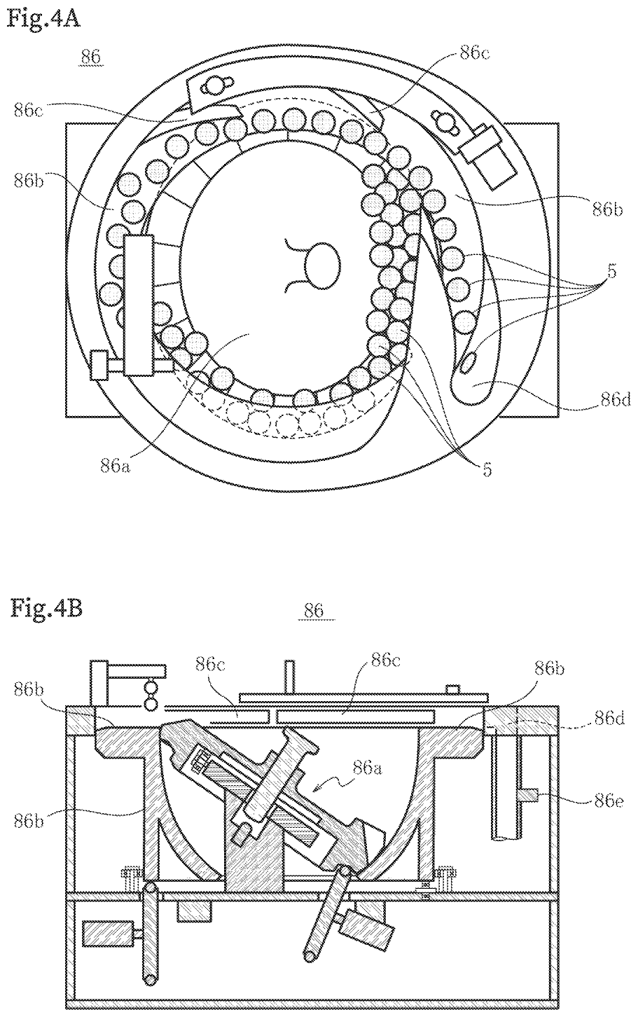

FIG. 4 illustrates the structure of a general-purpose medicine feeder 86 of a non-cassette, fixed container portion type. FIG. 4A is a plan view of an essential portion and FIG. 4B is a vertical sectional view of the essential portion.

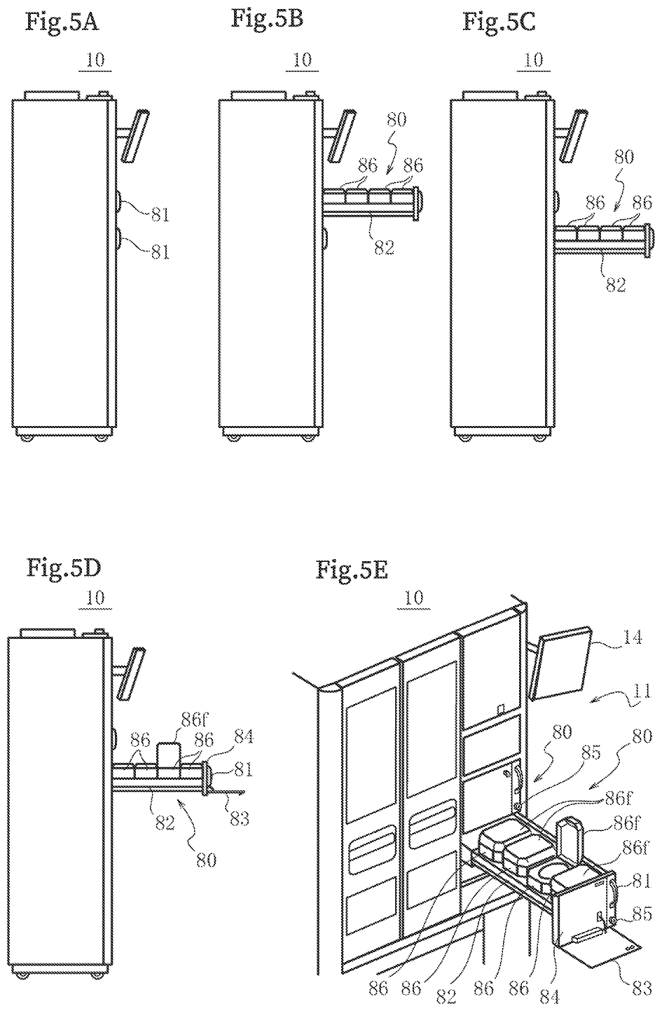

FIG. 5 illustrates the structure of the medicine feeder mount portion 80 and the procedure for drawing out the medicine feeder mount portion 80. FIGS. 5A to 5D are each a left side view of the medicine dispensing apparatus 10 and FIG. 5E is a perspective view of a front surface portion of the medicine storage 11.

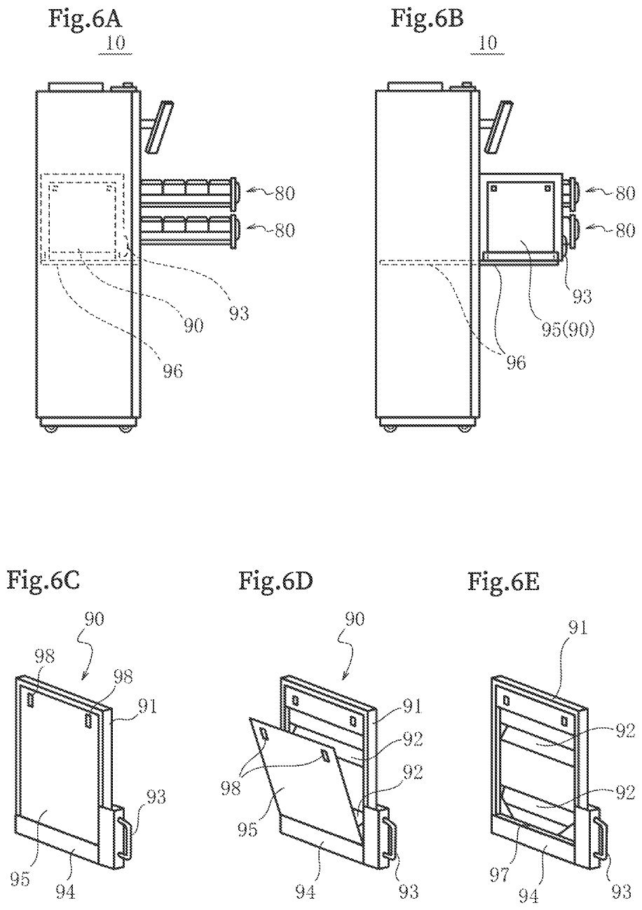

FIG. 6 illustrates the structure of the medicine guide structure 90 and the procedure for drawing out the medicine guide structure 90 from a housing. FIGS. 6A and 6B are each a left side view of the medicine dispensing apparatus 10. FIGS. 6C to 6E are each an exterior perspective view of the medicine guide structure 90. FIG. 1D discussed above is also an exterior perspective view of the medicine guide structure 90.

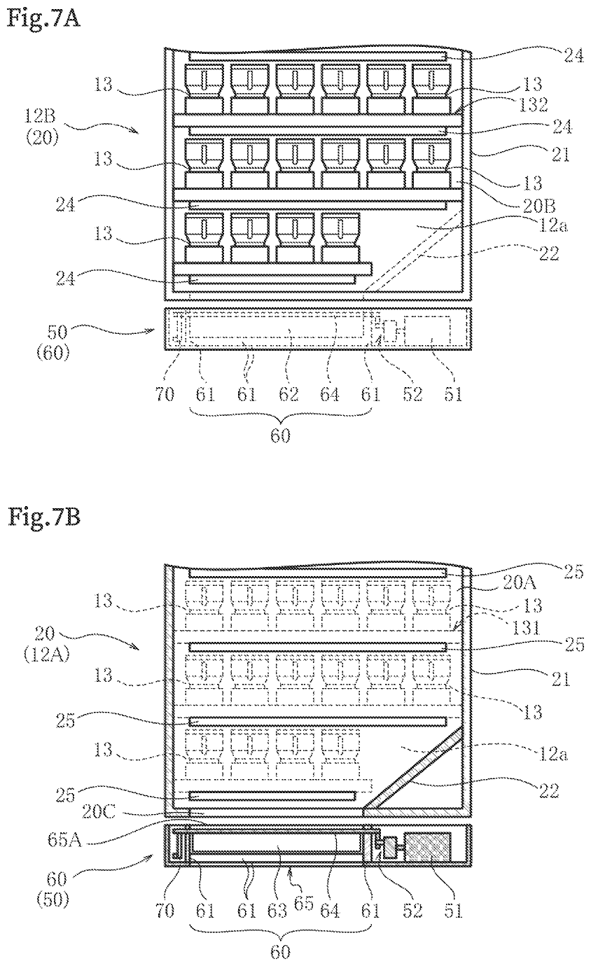

FIG. 7A is a left side view of the medicine feeder storage portion 12A and a temporary reserving structure storage portion 50, and FIG. 2B is a vertical sectional left side view of a medicine guide structure 20 and a temporary reserving structure 60.

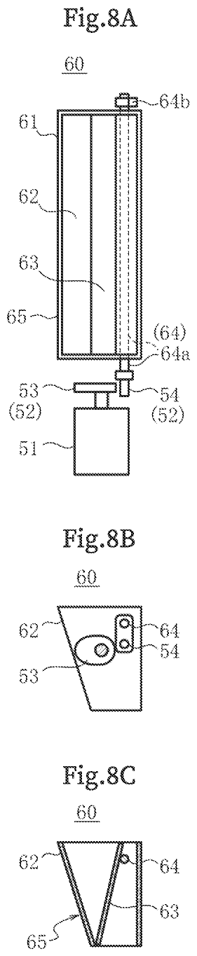

FIGS. 8A to 8C, 9A to 9C, and 10A to 10C are each a set of a plan view, a front view, and a vertical sectional view arranged from top to bottom, whereby the plan view in the upper part of each drawing illustrates the temporary reserving structure 60 at the lower end portion of the leftmost medicine feeder storage portion 12A and a drive mechanism (51 to 54) operable to directly drive the temporary reserving structure 60; the front view in the middle part illustrates the temporary reserving structure 60 and a part 53, 54 of the drive mechanism; and the front view in the lower part is a vertical sectional view of a reserving portion of the temporary reserving structure 60.

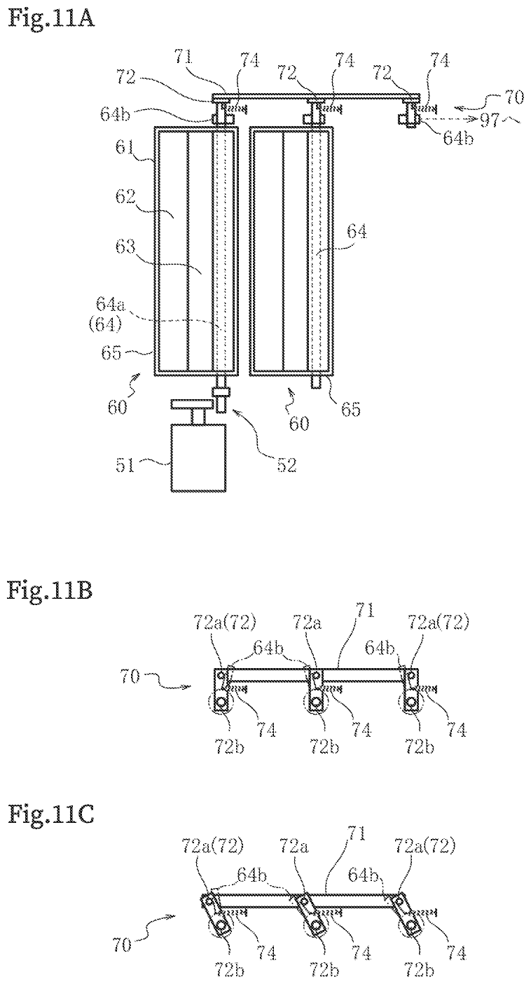

FIG. 11A is a plan view of two temporary reserving structures 60, 60 and a drive mechanism 51 to 54, and a power transmission link mechanism 70 therefor, and FIGS. 6B and 6C are each a front view of the link mechanism 70.

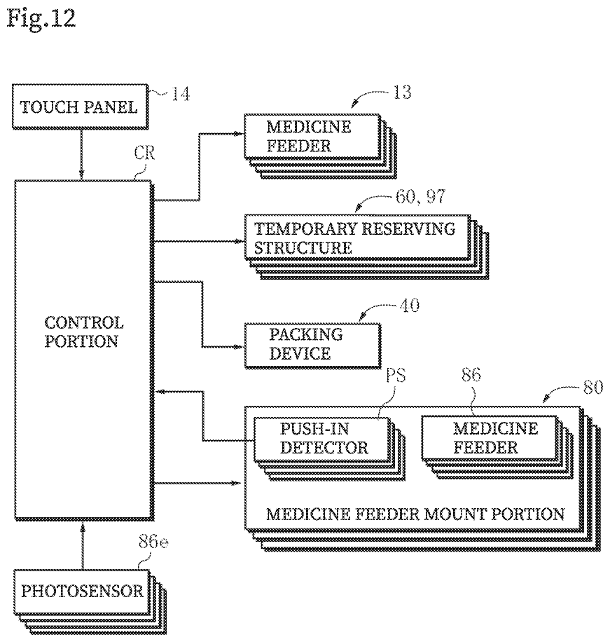

FIG. 12 is a block diagram illustrating the relationship of a control system.

The medicine dispensing apparatus 10 (see FIGS. 1 and 2) is obtained by improving a part of the medicine dispensing apparatuses discussed earlier and thus includes, as with such medicine dispensing apparatuses (also see Patent Documents 3 to 5), a medicine storage 11 in the upper portion of a housing, and a medicine collecting structure 30 and a packing device 40 disposed vertically in the lower portion of the housing. A medicine dispensation instruction etc. for a control portion CR in FIG. 12 operable to perform such operation control etc. can be given through communication from a medicine dispensing server etc. (not illustrated), or can be manually input via a touch panel 14 (operation input portion, display portion). The controller displays the state of operation of the medicine dispensing apparatus 10, information for a medicine dispensing person, etc. on the touch panel 14.

In the medicine dispensing apparatus 10 according to present example (see FIGS. 1 and 2), the temporary reserving structure storage portion 50 is also disposed in the middle portion of the housing, and located above the medicine collecting structure 30 and directly below the medicine storage 11. The medicine storage 11 includes a plurality of (three in the present example) medicine feeder storage portions 12A, 12B, 12C, which are disposed transversely side by side. The medicine feeder storage portions 12A, 12B can be individually drawn forward. The medicine feeder mount portions 80 of the medicine feeder storage portion 12C can be individually drawn forward out of the medicine storage 11 as necessary during medicine replenishment, maintenance, etc. (see FIGS. 1C and 2A).

A large number of medicine feeders 13 are mounted in the left medicine feeder storage portion 12A and the middle medicine feeder storage portion 12B. In the illustrated example (see FIGS. 1, 2, and 7), six rows and six columns of medicine feeders 13 are disposed on the left side (see the indication in the solid line in FIG. 7A), and six rows and six columns of medicine feeders 13 are disposed on the right side (see the indication in the broken line in FIG. 7B).

The medicine feeder storage portions 12A and 12BC each store the corresponding medicine feeder storage unit 131, 132 with a plurality of medicine feeders 13 included therein to contain the medicines and to consecutively discharge the medicines, and the medicine guide structure 20 disposed between a pair of adjacent medicine feeder storage units 131, 132 to guide the medicines discharged from the medicine feeders 13 included in the pair of medicine feeder storage units 131, 132 to an outlet port 20C located downward. In the illustrated example (see FIGS. 1 and 7), a medicine feeder storage unit 132 (see the indication in the solid line in FIG. 7A) in which six rows and six columns of medicine feeders 13 are disposed is disposed on the left side, and a medicine feeder storage unit 131 (see the indication in the broken line in FIG. 7B) in which six rows and six columns of medicine feeders 13 are disposed is also disposed on the right side, in the medicine feeder storage portion 12B at the middle.

The medicine feeder storage units 131 and 132 of the medicine feeder storage portions 12A are provided with a medicine feeder mount avoiding portion 12a, in which the medicine feeders 13 are not provided (see FIGS. 7A and 7B), in order to avoid interference with an inclined plate 22 provided at a front-side portion of the lower end portion of the medicine guide structure 20. The inclined plate 22 of the medicine guide structure 20 fulfills the function to guide medicines having fallen from above to the outlet port 20C configured to face an inlet opening portion 65A of a reserving portion 65 of the temporary reserving structure 60.

The medicine feeders 13 (see FIG. 3) are each a medicine feeder of a cassette mount-unmount type exclusively for specific medicines (medicine feeders of a medicine row front-rear splitting type), in which the base portion 13a configured for motor drive is fixed to shelf plates etc. of the medicine feeder storage portions 12A and 12B and the cassette 13b configured to contain a large number of medicines input in a random manner is removably mountable to the base portion 13a (see FIGS. 3A and 3B). The medicine replenishment etc. is performed with the cassette 13b being removed from the base portion 13a, and contained medicines 5 can be consecutively discharged, one at a time, according to control by the controller when the cassette 13b is mounted to the base portion 13a. The feature of the medicine feeders 13 exclusively for specific medicines is that front and rear sectioned chambers 13c, 13c for arranging the medicines 5 in line to be consecutively discharged are mechanically separated by partition members 13d (see FIGS. 3C and 3D).

The medicine guide structure 20 (see FIGS. 1 and 7) has a box shape in which a sliding-down passage is provided between two side walls 20A and 20B. One medicine guide structure 20 is integrated in each of the medicine feeder storage portions 12A, 12B, and 12C. The medicine guide structure 20 is configured to receive medicines, which have been discharged from the large number of medicine feeders 13 disposed in the left and right medicine feeder storage units 131 and 132, in the hollow inside, from six medicine guide path sliding-down ports 25, which are formed in the side walls 20A and 20B along the medicine feeder rows at intervals in the vertical direction, and to guide the medicines downward, and to allow the medicines to fall. The left and right medicine feeder storage units 131 and 132 include six medicine guide path sliding-down plates 24 provided under shelf portions on which the medicine feeders 13 are mounted and at intervals in the vertical direction to lead the medicines discharged from the medicine feeders 13 to the medicine guide path sliding-down ports 25.

Two upper and lower medicine feeder mount portions 80, 80 and a medicine guide structure 90 shared by the medicine feeder mount portions 80, 80 are mounted in the medicine feeder storage portion 12C on the right side in the medicine storage 11 of the medicine dispensing apparatus 10. In the illustrated example (see FIGS. 1, 5, and 6), the medicine feeder mount portions 80, 80 are disposed on the right side, and the medicine guide structure 90 is disposed on the left side.

The medicine feeder mount portions 80 can be individually drawn forward out of the medicine feeder storage portion 12C of the medicine storage 11 (see FIGS. 5A to 5C). When the upper and lower medicine feeder mount portions 80, 80 are all drawn out, the medicine guide structure 90 also can be drawn forward out of the medicine storage 11 (see FIGS. 6A and 6B).

In the medicine feeder mount portions 80, a plurality of (four in the example in FIGS. 1B, 5, and 6) medicine feeders 86 are mounted on a drawer member, that is, a drawer shelf 82, to be arranged in line in the front-rear direction. The front surface (see FIGS. 5D and 5E) of a front plate 84 is provided with a handle 81 to be engaged with fingers to be drawn out and pushed in, a lock 85 capable of switching whether or not a draw-out operation is allowed whether during automatic operation under control by the control portion CR or during manual operation not under control by the control portion CR, and a swing plate body 83 configured to be used as a small article placement site for temporary placement of small articles such as a medicine dispensation instruction slip during medicine dispensation. Push-in detectors PS (FIG. 12) configured to detect whether the medicine feeder mount portions 80 are pushed into or drawn out of the medicine storage 11 and sensors (not illustrated) configured to detect the open-close state of manually openable lids 86f provided on the medicine feeders 86 are also provided.

The medicine feeders 86 (see FIG. 4) to be used in the present embodiment are all general-purpose medicine feeders of a non-cassette, integral, and fixed type (medicine feeders of a medicine row front-rear non-splitting type). The medicine feeder 86 illustrated in FIG. 4 includes a peripheral wall located at the uppermost portion and having a void formed by hollowing the center portion of the peripheral wall in a circular shape, an annular rotary body 86b installed with the upper end portion of the annular rotary body 86b being freely fitted in the void of the peripheral wall or installed directly below the void of the peripheral wall, an inclined rotary body 86a installed in a void of the annular rotary body 86b to block the bottom portion of the void, a support mechanism configured to support the inclined rotary body 86a on the inner side and the annular rotary body 86b on the outer side so as to be axially rotatable, a rotary drive mechanism operable to drive rotation of the rotary bodies, and a regulation member 86c provided above the peripheral surface.

The annular surface at the upper end of the annular rotary body 86b serves as a medicine transfer path on which medicines 5, 5, . . . brought up through axial rotation of the inclined rotary body 86a are arranged and transferred. The regulation member 86c enters the path from the outer peripheral side to regulate the lateral width of the medicine transfer path so that extra medicines 5 are pushed back onto the inclined rotary body 86a on the inner side and the medicines 5, 5, . . . on the medicine transfer path are aligned in line. The medicines 5 arranged in line are fed into a fall-discharge port 86d one by one, and the falling medicines 5 are immediately detected by a photosensor 86e. Since no mechanical separation member such as the partition member 13d discussed above is present between the medicines 5, 5 arranged in the front-rear direction on the medicine transfer path, rotation of the annular rotary body 86b is decelerated before the completion of discharge or reversed immediately after the completion of discharge, as appropriate, during control for the rotational speed of the annular rotary body 86b in order to prevent discharge of excessive medicines 5.

The medicine replenishment etc. for the general-purpose medicine feeder 86 is performed by unlocking the lock 85 of the medicine feeder mount portion 80 in which the medicine feeder 86 is mounted, pulling the handle 81 to draw the medicine feeder mount portion 80 out of the medicine storage 81, opening a lid 86f of the target medicine feeder 86 which has been exposed, and putting medicines into the medicine feeder 86.

When the lid 86f is closed and the medicine feeder mount portion 80 is pushed into the medicine storage 11 after the medicine replenishment, then such operation is detected, and thereafter the lock 85 is locked to allow the locked medicine feeder 86 to consecutively discharge the contained medicines 5, one at a time, according to control by the control portion CR in FIG. 12.

The medicine guide structure 90 (see FIGS. 1 and 6) is mounted in the medicine feeder storage portion 12C in the state of being hidden behind the front plates 84, 84 of the upper and lower medicine feeder mount portions 80, 80 as discussed above. A handle 93 mounted on the front surface of the medicine guide structure 90 is also hidden behind the front plate 84. The medicine guide structure 90 is basically equivalent to a temporary reserving structure 97 corresponding to the temporary reserving structure 60 integrated under the medicine guide structure 20. In terms of shape, the medicine guide structure 90 has been downsized and deformed so as to be accommodated in the medicine feeder storage portion 12C. In terms of function, the medicine guide structure 90 guides medicines discharged from the feeders to the medicine collecting structure 30 located below the medicine guide structure 90, as with the medicine guide structure 20. The medicine guide structure 90 receives medicines discharged from the general-purpose medicine feeders 86, 86, . . . in the medicine feeder mount portions 80, 80 arranged vertically in the medicine feeder storage portion 12C.

The medicine guide structure 90 is supported by a drawer mechanism 96 (see FIG. 6A), and can be drawn forward out of the medicine storage 11 (see FIG. 6B). The medicine guide structure 90 is shorter in the length in the front-rear direction than the medicine feeder mount portions 80, and is always located in rear of the left end portion of the front plates 84, 84 of the medicine feeder mount portions 80, 80 on the right side (see FIGS. 1A, 1C, 5A, and 5D). As a result, the medicine guide structure 90 can be drawn out only when the upper and lower medicine feeder mount portions 80, 80 are all drawn out as discussed above (see FIGS. 6A and 6B).

The medicine guide structure 90 (see FIGS. 6C, 6D, 1D, and 6E) includes a thin box-shaped body portion 91, and a removable side plate 95 disposed on a releasable side surface on the left side, corresponding to one of the two side surfaces of the body portion 91 that is the farther from the medicine feeder mount portions 80, 80, to close the side surface when mounted. Medicine receiving ports 92, 92 are formed in a right side plate of the body portion 91 to receive medicines discharged from the medicine feeder mount portions 80, 80. The handle 93 is mounted at the front end of the body portion 91. A side plate holding member 94 is provided at a lower position at the lower end portion of the body portion 91 on the releasable side surface to receive the lower end portion of the side plate 95 from the lower side.

Small retention members 98 of a lever operation type, for example, are provided at the upper portion of the side plate 95. The releasable side surface of the body portion 91 is closed (see FIG. 6C) when the lower end portion of the side plate 95 is placed on and received by the side plate holding member 94 and then the side plate 95 is caused to stand upright with the retention members 98 being engaged with the body portion 91. Meanwhile, the upper portion of the side plate 95 is released from the releasable side surface of the body portion 91 (see FIG. 6D) when the retention members 98, 98 are all disengaged. The side plate 95 is held in a slightly tilted state, since the side plate holding member 94 includes a latch structure and receives the lower end portion of the side plate 95 with slight play.

Further, the medicine guide structure 90 is configured such that the side plate 95 is completely released from the body portion 91 (see FIG. 1D) to significantly expose the inside of the body portion 91 (see FIG. 6E) when the side plate 95 is lifted with hands at both the left and right ends of the side plate 95, for example. In the present embodiment, as illustrated in FIG. 1B, a temporary reserving structure 97 is disposed at the lower end portion of the medicine guide structure 90 (see FIGS. 1D and 6E). While the temporary reserving structure 97 is different from the temporary reserving structures 60 disposed under the medicine feeder storage portions 12A and 12B illustrated in FIG. 1B in that the temporary reserving structure 97 is integrated at the lower end portion of the medicine guide structure 90 and drawn out forward together with the medicine guide structure 90 and that the temporary reserving structure 97 is slightly reduced in size, the basic structure and function of the temporary reserving structure 97 are the same as those of the temporary reserving structures 60.

The medicine collecting structure 30 (see FIG. 1) is a large funnel-shaped member, and is located under three temporary reserving structures 60 located under the plurality of medicine feeder storage portions 12A to 12C of the medicine storage 11. The medicine collecting structure 30 is configured to collect not only medicines having fallen from the large number of medicine feeders 13, . . . , 13 by way of the medicine guide structures 20, 20 and further by way of the plurality of temporary reserving structures 60 but also medicines having fallen from the medicine feeders 86, 86 mounted in the medicine feeder mount portion 80 by way of the medicine guide structure 90 and further by way of the temporary reserving structure 60 and put such medicines into the packing device 40 located downward.

The packing device 40 is provided under the medicine collecting structure 30 discussed above, and operable to separately pack medicines in a packing band according to control by the controller when medicines converged to a falling position by the medicine collecting structure 30 fall to get into the packing device 40 from the medicine collecting structure 30.

In the present example, the temporary reserving structure storage portion 50 which stores two temporary reserving structures is also integrated in a lower part of the housing, in which the packing device 40 and the medicine collecting structure 30 discussed above are housed (see FIGS. 1A and 1B). The temporary reserving structure storage portion 50 is disposed above the medicine collecting structure 30, and mounted between the medicine guide structures 20 and the medicine collecting structure 30. As illustrated in FIG. 1B, a cylindrical or bottomless box-shaped guide 56 is provided in the temporary reserving structure storage portion 50 so as to be operable to guide the medicines falling from the temporary reserving structure 97 to the medicine collecting structure 30.

The temporary reserving structure storage portion 50 includes a number of temporary reserving structures 60, the number being the same as that of the medicine guide structures 20, and the medicine guide structures 20 and the temporary reserving structures 60 are disposed to be located vertically to make a one-to-one correspondence (see FIG. 1).

The medicine guide structure 90 can be considered as one obtained by slightly deforming the medicine guide structure 20, and the temporary reserving structure 97 can be considered as one obtained by slightly deforming the temporary reserving structure 60. Thus, the medicine dispensing apparatus 10 in this case can be considered as one in which the temporary reserving structures 60, 97 are provided under all the medicine guide structures 20, 90, the temporary reserving structures 60, 97 being operable to temporarily reserve medicines having fallen from the medicine guide structures 20, 90 and cause the medicines to collectively fall down into the medicine collecting structure 30.

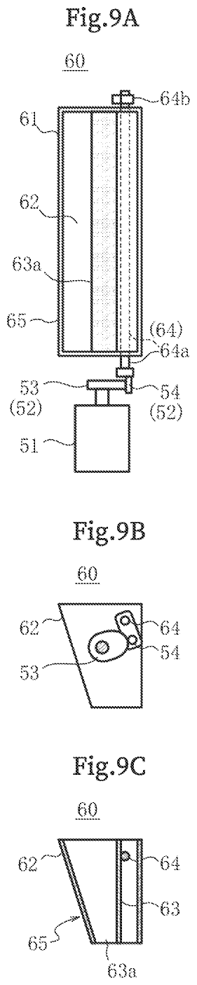

The temporary reserving structure 60 (see FIGS. 8 to 11) includes a body frame 61 elongated in the front-rear direction and opening upward, an oblique plate 62 fixed as one side wall of the body frame 61, an open-close member 63 facing the oblique plate 62 and capable of opening and closing the lower surface of the body frame 61, and a support shaft 64 coupled to the upper end of the open-close member 63. The support shaft 64 is driven to axially rotate in a limited range to swing the open-close member 63, in order to close the opened lower surface of the body frame 61 (see FIGS. 8A and 9A), open the lower surface to cause an opening 63a to appear (see FIG. 8B), and further make the opening 63a larger (see FIG. 8C). The reserving portion 65 is constituted by the body frame 61, the oblique plate 62, and the open-close member 63. In the present embodiment, a drive mechanism (51, 52, 70) provides a closing drive force or an opening drive force to an open-close mechanism (62 to 64) of the temporary reserving structure 60. The temporary reserving structure 97 provided at the lower end portion of the medicine guide structure 90 also has the same structure as the above-discussed temporary reserving structure 60 though the size thereof is small.

When medicines discharged from the large number of medicine feeders 13 fall down while being guided by the medicine guide structure 20 over the temporary reserving structure 60, the temporary reserving structure 60 receives the medicines in the closed state, temporarily reserves the medicines (see FIG. 8A), and allows the medicines to fall down into the medicine collecting structure 30 by collectively releasing the reserved medicines from the opening 63a by opening the lower surface at an appropriate timing. Temporary reservation by the temporary reserving structure 60 resolves fluctuations in the medicine collection time due to fluctuations in the discharge timing among the medicine feeders 13, differences in the fall path length among the medicine guide structures 20, and hence fluctuations in the falling time, allowing medicines for each packing set to collectively fall together into the medicine collecting structure 30. This serves to speed up medicine dispensation by shortening the input waiting time of the packing device 40.

When medicines discharged from the medicine feeders 86 fall while being guided by the medicine guide structure 90 over the temporary reserving structure 97 provided at the lower end portion of the medicine guide structure 90, the temporary reserving structure 97 similarly receives the medicines in the closed state, temporarily reserves the medicines, and allows the medicines to fall to the medicine collecting structure 30 by collectively releasing the reserved medicines from the opening by opening the lower surface at an appropriate timing. However, the temporary reserving structure 97 in this case is different from the temporary reserving structures 60, which are fixed at all times, in that the temporary reserving structure 97 is reduced in size as discussed above and that the temporary reserving structure 97 is drawable out of the housing as the medicine guide structure 90 is drawn out of the medicine feeder storage portion 12C.

The basic configuration of the temporary reserving structures 60 and the temporary reserving structure 97 provided at the lower end portion of the medicine guide structure 90 is generally based on that according to the related art. In the medicine dispensing apparatus 10 according to the present embodiment, while being based on the conventional basic configuration, unlike the related art, an electric motor 51 operable to drive the temporary reserving structures 60, 97 is located in front of the temporary reserving structure 60 (see FIGS. 2C, 7, 8, and 9A), rather than in rear of the temporary reserving structures 60, 97.

The electric motor 51 is preferably integrated at an end portion in the left-right direction in the housing 10A. In the present example (see FIG. 9A), the electric motor 51 is installed only in front of the temporary reserving structure 60 corresponding to the medicine feeder storage portion 12A located at the left end.

A cam mechanism 52 for power transmission is provided between a rotation output shaft of the electric motor 51 and the front end portion of a support shaft 64 (64a) of the temporary reserving structure 60 located in rear of the electric motor 51 (see FIG. 9A).

Each time a driver (cam) 53 of the cam mechanism 52 is caused to make one rotation by the electric motor 51, a follower (following element) 54 of the cam mechanism 52 is swung by several tens of degrees, and accordingly the support shaft 64 is reciprocally axially rotated by the same angle, and accordingly the open-close member 63 opens and closes the bottom of the temporary reserving structure 60 (see FIG. 8), switching the medicine reserving state of the temporary reserving structure 60.

The support shaft 64 is integrated in the temporary reserving structure 60 in the state of extending in the front-rear direction along the temporary reserving structure 60 elongated in the front-rear direction. When the front end portion of the support shaft 64 is axially rotated in a limited range by the electric motor 51 and the cam mechanism 52, the axial rotational motion is transmitted to a rear cam mechanism 64b at the rear end portion of the support shaft 64 (see FIGS. 8A and 9A), and further transmitted from the rear cam mechanism 64b to a swing end portion 72a of a swing member 72 of the link mechanism 70 (see FIGS. 11B and 11C). Thus, the support shaft 64 also serves as a transmission shaft 64a for transmission to the link mechanism 70 (transmission mechanism) located in rear of the temporary reserving structure 60. On the other hand, the support shafts 64 of the other temporary reserving structures 60 corresponding to the other medicine feeder storage portions 12B serve as follower shafts configured to receive drive of the link mechanism 70 (see FIG. 11). The cam mechanism 52 is configured to convert motion for one rotation of the output shaft of the electric motor 51 into partial reciprocal rotational motion of the transmission shaft 64a. In the present embodiment, as illustrated in FIG. 11A, the rear cam mechanism 64b located at the end portion of the link mechanism 70 is engaged with an engaged drive link, not illustrated, which is located inside the temporary reserving structure 90 disposed at the lower end portion of the medicine guide structure 90 so as to transmit the force of the electric motor 51 to the engaged drive link. As a result, two temporary reserving structures, namely, both the temporary reserving structure 60 and the temporary reserving structure 97 provided at the lower end potion of the medicine guide structure 90 are driven by a single electric motor 51. The engaged drive link, not illustrated, inside the temporary reserving structure 97 is configured to be disengaged with the rear cam mechanism 64b located at the end portion of the link mechanism 70 when sliding the medicine guide structure 90 forward, and to be engaged with the rear cam mechanism 64b when positioning the medicine guide structure 90 way in the back of the housing.

Further, in order to enable the arrangement relationship discussed above, that is, the arrangement in which the drive mechanism (51 to 54) including the electric motor 51 is located in front of the temporary reserving structure 60, without breaking a basic requirement that medicines having fallen from the medicine guide structures 20 should be reliably put into the temporary reserving structures 60 under the medicine guide structures 20, at least the medicine feeder storage portion 12A at the left end and the corresponding medicine guide structure 20 (see FIGS. 1 and 2) are subjected to a further requirement that is not required for the medicine feeder storage portions 12B and 12C at which the electric motor 51 is not disposed or the corresponding medicine guide structures 20 and the medicine guide structure 90.

Specifically (see FIGS. 2 and 7), a front-side portion (specifically, the inclined plate 22) of a lower end portion of an inner wall portion of the medicine guide structure 20 integrated in the medicine feeder storage portion 12A at which the electric motor 51 is disposed is located in rear of a front-side portion 21 at an upper end portion or an intermediate portion of the inner wall portion of the medicine guide structure 20. The upper end of the front-side portion (22) of the lower end portion of the inner wall portion of the medicine guide structure 20 is connected to the lower end of the front-side portion 21 at the upper end portion or the intermediate portion of the inner wall portion of the medicine guide structure 20, and the lower end of the front-side portion 22 at the lower end portion of the inner wall portion of the medicine guide structure 20 is retracted to a location immediately above the front end of the body frame 61 of the temporary reserving structure 60 located therebelow. As a result, when medicines discharged from the medicine feeders 13 in the upper row are led to the internal space of the medicine guide structure 20 by the medicine guide path sliding-down plate 24 to fall to the medicine feeder mount avoiding portion 12a, the medicines get into the temporary reserving structure 60 with the falling direction of the medicines being changed obliquely rearward by the upper surface of the inclined plate of the front-side portion (inclined plate 22) at the lower end portion of the inner wall portion of the medicine guide structure 20, since the front-side portion (inclined plate 22) of the lower end portion of the inner wall portion of the medicine guide structure 20 is inclined.

The link mechanism 70 (see FIGS. 2 and 7) is a transmission mechanism operable to transmit axial rotational motion, for a limited angle, of the transmission shaft 64a driven by the cam mechanism 52, which converts motion for one rotation of the output shaft of the electric motor 51 into swing motion, to the support shafts 64 of the two temporary reserving structures 60 corresponding to the other medicine feeder storage portions 12B and 12C by way of the rear cam mechanisms 64b. The link mechanism 70 is provided way in the back of the housing 10A, and located in rear of the plurality of (three in the present example) temporary reserving structures 60, 60, 97. The link mechanism 70 (see FIG. 6) includes a rod-like coupling member 71 elongated transversely, three short swing members 72 disposed to make a one-to-one correspondence with the three temporary reserving structures 60, and three biasing springs 74 disposed to make a one-to-one correspondence with the plurality of swing members 72. The swing end portion 72a of the swing member 72 is coupled to the coupling member 71 in an axially rotatable state, and a swing support portion 72b of the swing member 72 is coupled to a support member (not illustrated) provided way in the back of the housing 10A in an axially rotatable state (see FIG. 4A).

When the transmission shaft 64a, that is, the leftmost support shaft 64, is axially rotated in a limited range against the reaction force of the biasing spring 74, the other support shafts 64, 64 are also axially rotated accordingly (see FIG. 11C). When rotational drive of the transmission shaft 64a is stopped, all the support shafts 64, 64, 64 including the support shaft 64a are returned to the original state by the biasing force of the biasing springs 74 (see FIG. 11B). Therefore, each time the output shaft of the electric motor 51 makes one rotation, the cam mechanism 52, the transmission shaft 64a, and the link mechanism 70 operate to swing all the open-close members 63, and consequently open-close operation is performed in all the temporary reserving structures 60, 60, 97.

The use and the operation of the medicine dispensing apparatus 10 according to the above embodiment will be described with reference to the drawings. FIG. 2D is an exterior perspective view in which the leftmost medicine feeder storage portion 12A, among the three medicine feeder storage portions 12A to 12C, has been drawn forward out of the medicine storage 11 and a left side plate 11a of the medicine storage 11 has been removed.

FIG. 6A is a left side view of the medicine dispensing apparatus 10 in which the upper and lower medicine feeder mount portions 80, 80 have all been drawn forward out of the medicine storage 11, and FIG. 6B is a left side view of the medicine dispensing apparatus 10 in which the medicine guide structure 90 has also been drawn forward out of the medicine storage 11. FIG. 6C is an exterior perspective view of the medicine guide structure 90 which has been drawn out, and FIG. 6D is an exterior perspective view of the medicine guide structure 90 in which the side plate 95 is being removed from the body portion 91. Further, FIGS. 1D and 6E are each an exterior perspective view of the medicine guide structure 90 in which the side plate 95 has been removed from the body portion 91.

The general method of use and the dispensing operation of the medicine dispensing apparatus 10 are basically similar to those of the medicine dispensing apparatuses according to the related art. The medicine feeders 13 of a cassette mount-unmount type exclusively for specific medicines are preferably used for frequently used medicines. In that case, the medicine feeder storage portions 12A, 12B are drawn forward out of the medicine storage 11, a large number of medicine feeders 13 exposed are filled with predetermined medicines, and then the medicine feeder storage portions 12A, 2B are pushed back into the medicine storage 11. Meanwhile, the general-purpose medicine feeders 86 of a non-cassette, fixed container portion type are preferably used for the other medicines. In that case, the medicine feeder mount portion 80 is drawn forward out of the medicine feeder storage portion 12C of the medicine storage 11, the medicine feeders 86 exposed are filled with predetermined medicines, and then the medicine feeder mount portion 80 is pushed back into the medicine feeder storage portion 12C.

In either case, when a medicine dispensation instruction based on a prescription is given to the medicine dispensing apparatus 10 by operating the touch panel 14 while seeing a guidance indication etc., although not illustrated or described in detail, indicated medicines are discharged from the medicine feeders 13, 86 containing such medicines, led by the medicine guide structures 20 and the medicine guide structure 90 to the temporary reserving structures 60, 60, 97 under the medicine guide structures 20 and the medicine guide structure 90, and temporarily retained there. Then, the electric motor 51 causes the output shaft thereof to make one rotation after the lapse of an appropriate time, and thus the open-close members 63 of all the temporary reserving structures 60, 60, 97 are swung via the cam mechanism 52, the transmission shaft 64a, and the link mechanism 70 in response to the rotation of the electric motor 51. Therefore, all the medicines retained by the temporary reserving structures 60, 60, 97 fall together from the temporary reserving structure storage portion 50 to be led to the packing device 40 by the medicine collecting structure 30.

In this manner, the medicines are separately packed in a package body one after another. In that event, moreover, the medicine fall path from the medicine feeders 13, 86 to the temporary reserving structures 60, 97 and the medicine fall path from the temporary reserving structures 60, 97 to the packing device 40 are separated by open-close operation of the temporary reserving structures 60, 97 for most of the time, and therefore fall of medicines on the side of the medicine guide structures 20 and the medicine guide structure 90 and fall of medicines on the side of the medicine collecting structure 30 can be mostly performed concurrently, reducing the dispensing time.

When it becomes necessary to perform regular check, troubleshooting, etc. for the electric motor 51 after repeatedly performing such medicine dispensing operation, the medicine feeder storage portion 12A in which the electric motor 51 is disposed is drawn forward out of the medicine storage 11, and the left side plate 11a is removed from the medicine storage 11 (see FIG. 2D). Then, the electric motor 51 installed at a front-side location immediately on the inner side of the left side surface of the medicine dispensing apparatus 10 is exposed, and thus, maintenance for the electric motor 51 is performed from the front portion of the side surface of the medicine dispensing apparatus 10.

In this manner, with the medicine dispensing apparatus 10 according to the present embodiment, manual work for the electric motor 51 can be performed without going to the rear side of the housing 10A, and thus maintenance for the electric motor 51 can be easily performed.

When discharge of excessive medicines is detected based on a signal from the photosensor 86e (FIGS. 4B and 12) for any of the general-purpose medicine feeders 86 of a non-cassette, fixed container portion type during medicine dispensing operation, the medicine dispensing operation is immediately stopped temporarily by the control device before the temporary reserving structures 60 including the temporary reserving structure 97 are opened.

In that state, the temporary reserving structures 60 are maintained in the closed state by the effect of the biasing springs 74 on the open-close members 63, and thus the excessively discharged medicines remain in the temporary reserving structure 97 of the medicine guide structure 90 together with appropriately discharged medicines.

In addition to an indication that discharge of excessive medicines has occurred, an indication specifying the medicine feeder 86 that has discharged the excessive medicines and the relevant medicine feeder mount portion 80 is displayed on the touch panel 14 by the control portion CR. Further, the lock 85 is unlocked by the control portion CR for the medicine feeder mount portion 80 in which the medicine feeder 86 which has discharged the excessive medicines is mounted and all the medicine feeder mount portions 80 that share the medicine guide structure 90 with the medicine feeder mount portion 80.

Consequently, the medicine dispensing apparatus 10 is brought into a state in which the excessively discharged medicines can be manually collected from the medicine guide structure 90.

Thus, a medicine dispensing person etc. draws the relevant medicine feeder mount portions 80, 80 forward out of the housing (see FIG. 6A) while referencing display on the touch panel 14, also draws the relevant medicine guide structure 90 forward out of the housing (see FIG. 6B), removes the side plate 95 from the medicine guide structure 90 (see FIGS. 6C, 6D, 1D, and 6E), takes the excessively discharged medicines out of the temporary reserving structure 97 under the medicine guide structure 90, and returns the excessively discharged medicines to the medicine feeder 86 which discharged the excessive medicines by opening and closing the lid 86f of the medicine feeder 86 (see FIGS. 5D and 5E). For the temporary reserving structure 97 at the lower end portion of the medicine guide structure 90, the person looks into the temporary reserving structure 97 obliquely from above (see FIG. 6E), takes the excessively discharged medicines out of the temporary reserving structure 97 using tweezers etc., and returns the excessively discharged medicines to the medicine feeder 86 which discharged the excessive medicines by opening and closing the lid 86f of the medicine feeder 86 (see FIGS. 5D and 5E).

When the relevant medicine guide structure 90 and the medicine feeder mount portions 80 are pushed back into the housing, the manual work of collection and recovery is completed, and the medicine dispensing apparatus 10 is brought into a state in which automatic packing can be resumed.

When the medicine dispensing person etc. gives an instruction to resume automatic packing by operating the touch panel 14, the control portion CR of the medicine dispensing apparatus 10 confirms that the relevant medicine feeder mount portion 80 is housed in the housing, and then locks the lock 85.

Consequently, the medicine feeder storage portion 12C is brought into a state in which the medicine feeder mount portions 80 are not drawn out in an undesired manner, the medicine dispensing apparatus 10 is returned to a state at the start of temporary stop, and automatic packing is resumed by the control portion CR.

Thus, even if the medicines should be discharged excessively from the general-purpose medicine feeders 86 of a non-cassette type and fixed container portion type, automatic dispensing can be resumed without wasting the excessively discharged medicines and moreover easily.

### [Others]

While the electric motor 51 is provided only under the leftmost one of the medicine feeder storage portions 12A to 12C in the above embodiment, a suitable installation location of the electric motor 51 is not limited thereto, and may be under the rightmost medicine feeder storage portion 12C, or an electric motor may be installed at both such locations so that targets are driven in a distributed manner.

In the description of the above embodiment, automatic packing is not continued without extracting excessively discharged medicines when discharge of excessive medicines has occurred. If it is desired to do so, it may be configured such that an instruction for immediate resumption is given on the touch panel 14, for example, to resume the automatic packing operation, namely, to start the interrupted packing again and add a record of failure with a marker, tag, etc. to a package body with the excessively discharged medicines.

While a manual medicine dispensing device (manual tablet dispensing device) is not integrated in the medicine dispensing apparatus in the above example, a manual medicine dispensing device may be integrated in the medicine dispensing apparatus according to the present invention (see Patent Document 1, for example). In that case, the medicine dispensing apparatus can be compactly implemented, even under a condition that the medicine feeder storage portions can be drawn out forward, by arranging the manual medicine dispensing device side by side with the temporary reserving structure storage portion 50, although such an arrangement is not essential.

### INDUSTRIAL APPLICABILITY

With the present invention, when an excessive medicine is discharged from a general-purpose medicine feeder, a series of control is performed such that the excessively discharged medicine etc. is reserved in a temporary reserving structure and manual work of extracting the excessively discharged medicine from the temporary reserving structure is allowed in response to detection of such discharge. Thus, it is possible to avoid undesired packing easily and adequately, even if automatic medicine dispensation is temporarily stopped. Moreover, the excessively discharged medicine that has been extracted can be returned to the source medicine feeder before pushing back the feeder storage portion, and thus is not wasted. As a result, a user etc. can be given a sufficient sense of security or stable operation even if not only medicine feeders of a cassette mount-unmount type but also general-purpose medicine feeders of a fixed container portion type are mounted.

### DESCRIPTION OF REFERENCE NUMERALS

5 medicine (tablet)
10 medicine dispensing apparatus
10A housing
11 medicine storage
11a side plate
12 medicine feeder storage portion
12a medicine feeder mount avoiding portion
12A medicine feeder storage portion (on electric motor disposed side, with cassette-type feeders mounted therein)
12B medicine feeder storage portion (on electric motor non-disposed side, with cassette-type feeders mounted therein)
12C medicine feeder storage portion (on electric motor non-disposed side, with fixed-type feeders mounted therein)
13 medicine feeder (cassette-type feeder, medicine feeder exclusively for specific medicines)
13a base portion (driving portion)
13b cassette
13c sectioned chamber
13d partition member
14 touch panel (operation input portion, display portion)
20 medicine guide structure
21 front-side portion of upper end portion or intermediate portion
22 front-side portion of lower end portion
23 middle or rear-side portion of lower end portion
24 medicine guide path sliding-down plate
25 medicine guide path sliding-down port
26 medicine feeder non-mount portion
30 medicine collecting structure
40 packing device
50 temporary reserving structure storage portion
51 electric motor
52 cam mechanism
53 driver (cam)
54 follower (following element)
60 temporary reserving structure
61 body frame
62 oblique plate
63 open-close member
63a opening
64 support shaft
64a transmission shaft (support shaft)
64b rear cam mechanism
70 link mechanism (transmission mechanism)
71 coupling member
72 swing member
72a swing end portion
72b swing support portion
74 biasing spring
80 medicine feeder storage portion
81 handle
82 drawer member
83 swing plate body
84 front plate
85 lock
86 medicine feeder (general-purpose medicine feeder)
86a inclined rotary body
86b annular rotary body
86c regulation member
86d fall-discharge port
86e photosensor
86f lid
90 medicine guide structure
91 body portion
92 medicine receiving port
93 handle
94 side plate holding member
95 side plate
96 drawer mechanism
97 temporary reserving structure
98 retention member

1. A medicine dispensing apparatus comprising:
a housing;
a plurality of medicine feeders configured to contain medicines and consecutively discharge the medicines, and a plurality of medicine feeder storage units each configured to store the plurality of medicine feeders;
a plurality of medicine guide structures provided in correspondence with the medicine feeder storage units to guide the medicines discharged from the plurality of medicine feeders included in the corresponding medicine feeder storage unit to a single outlet port located at a lower part of the corresponding medicine guide structure;
a plurality of medicine feeder storage portions each configured to store the corresponding medicine feeder storage unit and the corresponding medicine guide structure;
a medicine collecting structure disposed in the housing under the plurality of medicine guide structures to collect the medicines having fallen from the plurality of medicine guide structures;
a packing device provided in the housing under the medicine collecting structure to separately pack the medicines discharged from the medicine collecting structure; and
a control portion configured to control operation of the plurality of medicine feeders and the packing device,
the medicine feeder storage unit included in one of the plurality of medicine feeder storage portions including a plurality of medicine feeder mount portions in which a plurality of general-purpose medicine feeders are mounted on a plurality of drawer shelfs provided vertically and configured to be individually drawable, the plurality of general-purpose medicine feeders each including a container portion and a successive discharge mechanism portion that are integrated with each other, and
one of the plurality of medicine guide structures that is provided in correspondence with the medicine feeder storage unit including the plurality of medicine feeder mount portions being allowed to be drawn out of the housing when all of the plurality of medicine feeder mount portions are drawn out, wherein:
a temporary reserving structure is provided at a lower end portion of the one of the plurality of medicine guide structures that is provided in correspondence with the medicine feeder storage unit including the plurality of medicine feeder mount portions, the temporary reserving structure being operable to temporarily reserve the medicines fallen from the medicine guide structure and cause the medicines to collectively fall down into the medicine collecting structure;
the control portion is configured to also control operation of the temporary reserving structure; and
when it is detected that an excessive medicine has been discharged from the medicine feeder included in the medicine feeder storage unit including the plurality of medicine feeder mount portions during packing operation, the control portion temporarily stops the packing operation and causes the temporary reserving structure to reserve the medicines, and allows an operation to draw out the plurality of medicine feeder mount portions included in the medicine feeder storage unit for the relevant medicine feeder storage unit, and thereafter allows resuming the packing operation when it is detected that the plurality of medicine feeder mount portions are drawn out of the housing and pushed back.

2. The medicine dispensing apparatus according to claim 1, further comprising
a display member configured to indicate the medicine feeder that has discharged an excessive medicine when such excessive discharge is detected.

3. The medicine dispensing apparatus according to claim 1, wherein
the control portion causes the medicine feeders included in the medicine feeder storage unit including the plurality of medicine feeder mount portions to perform medicine discharge operation and causes the packing device to perform the packing operation without waiting for an instruction for the packing operation when operating power is turned on and during other initial operation.

4. The medicine dispensing apparatus according to claim 1, wherein:
a plurality of temporary reserving structures each including a reserving portion are also provided under the plurality of medicine feeder storage units included in the plurality of medicine feeder storage portions other than the one of the plurality of medicine feeder storage portions, the plurality of temporary reserving structures each being operable to temporarily reserve, in the reserving portions, the medicines fallen from a corresponding one of the plurality of medicine guide structures and cause the medicines to collectively fall down into the medicine collecting structure;
the medicine dispensing apparatus further includes a drive mechanism operable to drive the plurality of temporary reserving structures;
a front-side portion of a lower end portion of an inner wall portion of at least one of the plurality of medicine guide structures is located in rear of a front-side portion of an upper end portion of the inner wall portion of the at least one medicine guide structure;
a front end of the reserving portion of the temporary reserving structure is located in rear of a front surface of the housing; and
an electric motor operable to provide a closing drive force or an opening drive force to the drive mechanism is located in front of the reserving portion.

5. The medicine dispensing apparatus according to claim 1, wherein:
the plurality of medicine feeder storage portions are arranged side by side in the housing;
a transmission shaft is provided to extend in a front-rear direction along a reserving portion of the temporary reserving structure provided for the medicine guide structure in any one of the plurality of medicine feeder storage portions;
a transmission mechanism operable to transmit motion of the transmission shaft to a plurality of open-close mechanisms provided for the plurality of medicine feeder storage portions is provided in rear of the reserving portion inside the housing; and
the electric motor drives the transmission shaft.

6. The medicine dispensing apparatus according to claim 5, wherein
the electric motor is located in front of the reserving portion of the temporary reserving structure in one of the plurality of medicine feeder storage portions that is located closest to a side in the housing.

7. The medicine dispensing apparatus according to claim 6, wherein
the transmission shaft serves as a support shaft for the open-close mechanism of the temporary reserving structure.

8. The medicine dispensing apparatus according to claim 5, wherein
a cam mechanism operable to convert motion for one rotation of an output shaft of the electric motor into reciprocal rotational motion of the transmission shaft is provided between the electric motor and the transmission shaft, and the transmission mechanism is composed of a link mechanism.

9. The medicine dispensing apparatus according to claim 8, wherein
the link mechanism of the transmission mechanism drives the open-close mechanism of the temporary reserving structure provided at the lower end portion of the medicine guide structure provided in correspondence with the medicine feeder storage unit including the plurality of medicine feeder mount portions.

10. The medicine dispensing apparatus according to claim 2, wherein
the control portion causes the medicine feeders included in the medicine feeder storage unit including the plurality of medicine feeder mount portions to perform medicine discharge operation and causes the packing device to perform the packing operation without waiting for an instruction for the packing operation when operating power is turned on and during other initial operation.

11. The medicine dispensing apparatus according to claim 6, wherein
a cam mechanism operable to convert motion for one rotation of an output shaft of the electric motor into reciprocal rotational motion of the transmission shaft is provided between the electric motor and the transmission shaft, and the transmission mechanism is composed of a link mechanism.

12. The medicine dispensing apparatus according to claim 11, wherein
the link mechanism of the transmission mechanism drives the open-close mechanism of the temporary reserving structure provided at the lower end portion of the medicine guide structure provided in correspondence with the medicine feeder storage unit including the plurality of medicine feeder mount portions.

13. The medicine dispensing apparatus according to claim 7, wherein
a cam mechanism operable to convert motion for one rotation of an output shaft of the electric motor into reciprocal rotational motion of the transmission shaft is provided between the electric motor and the transmission shaft, and the transmission mechanism is composed of a link mechanism.

14. The medicine dispensing apparatus according to claim 13, wherein
the link mechanism of the transmission mechanism drives the open-close mechanism of the temporary reserving structure provided at the lower end portion of the medicine guide structure provided in correspondence with the medicine feeder storage unit including the plurality of medicine feeder mount portions.
